(19) United States
(12) Patent Application Publication
(10) Pub. No.: US 2012/0137844 A1
(43) Pub. Date: Jun. 7, 2012

(54) DEVICE AND METHOD FOR CUTTING FOOD PRODUCTS

(75) Inventor: Günther Weber, Gross Nemerow (DE)

(73) Assignee: WEBER MASCHINENBAU GMBH BREIDENBACH, Breidenbach (DE)

(21) Appl. No.: 13/376,339

(22) PCT Filed: May 18, 2010
(86) PCT No.: PCT/EP2010/003036

§ 371 Date: Feb. 21, 2012

(30) Foreign Application Priority Data
Jun. 3, 2009 (DE) 10 2009 023 728.3

(51) Int. Cl. B26D 7/06; B26D 5/20

(52) U.S. Cl. 83/13; 83/403.1

(57) ABSTRACT

A device for cutting food products for a slicer is provided including a product feed, at least one cutting blade, a common drive, and respective transmission units. The product feed includes a plurality of conveying devices arranged generally parallel next to one another, each having a conveying speed for simultaneously feeding a plurality of food products to a cutting plane. A respective one of the plurality of conveying devices is associated with each of the plurality of food products. At least one cutting blade is configured for moving in the cutting plane. The common drive is for the plurality of conveying devices. The respective transmission units are for each of the plurality conveying devices. Each transmission unit has a variable transmission ratio. The transmission ratios are variable to individually vary each of the conveying speeds of the plurality of conveying devices.

### CROSS-REFERENCES TO RELATED APPLICATIONS

This patent application claims priority to International Application No. PCT/EP2010/003036 filed on May 18, 2010, which claims priority to German application DE102009023728.3 filed on Jun. 3, 2009, both of which are incorporated herein by reference in their entirety.

### FIELD OF THE INVENTION

The present invention relates to an apparatus or device and to a method for slicing or cutting food products.

### BACKGROUND

Different types of food slicing apparatus are known in the prior art. For example, so-called high-performance slicers are used to slice food products such as meat, sausage or cheese at a high cutting speed. In an endeavor further to increase the cutting performance, such apparatus can have a product feed which is made to feed a plurality of product loaves or product bars. The products are positioned in parallel next to one another, and a common cutting blade moves in a cutting plane that extends perpendicular to the product conveying direction. It is possible in this manner to utilize a single cutting apparatus—with a correspondingly large blade—for the simultaneous cutting of a plurality of products.

A high-performance slicer with independent product feeds for two products to be conveyed in parallel and to be sliced simultaneously is described in European patent EP 0 713 753 B1. In this slicer, each product to be sliced is pushed in the direction of the blade by means of a separately driven gripping claw that engages at the rear product end. The gripping claws each have their own drive, and can accordingly be driven completely independently of one another at different advance speeds so that it is possible to vary the thickness of the cut off product slices for the conveyed products by means of the individual product feed drives independently of one another during slicing.

Slicers with mutually independent product feed drives for two products to be sliced simultaneously are disclosed in U.S. Pat. Nos. 3,605,837 and 3,927,319. Each product is in this respect is clamped during slicing between two oppositely disposed continuous belt conveyors, which are oriented vertically and can both hold the product and feed it to a cutting plane at a variable feed rate. Each pair of continuous belt conveyors provided for one respective product has its own drive for the product feed, with the drives being completely independent of one another so that the product feed rates of the products to be sliced can be varied independently of one another.

Above all, the relatively high effort required for the provision of a plurality of mutually independent drives including the associated control devices is problematic with these known apparatuses.

### SUMMARY

In one embodiment of the invention, the simultaneous cutting of a plurality of food products conveyed in parallel, with the thickness of the cut off product slices that may be varied individually for each product is simplified.

In one embodiment, a device for cutting food products for a slicer is provided including a product feed, at least one cutting blade, a common drive, and respective transmission units. The product feed includes a plurality of conveying devices arranged generally parallel next to one another, each having a conveying speed for simultaneously feeding a plurality of food products to a cutting plane. A respective one of the plurality of conveying devices is associated with each of the plurality of food products. At least one cutting blade is configured for moving in the cutting plane. The common drive is for the plurality of conveying devices. The respective transmission units are for each of the plurality conveying devices. Each transmission unit has a variable transmission ratio. The transmission ratios are variable to individually vary each of the conveying speeds of the plurality of conveying devices.

The device in accordance with one aspect of the invention has a product feed. The product feed includes a plurality of conveying devices arranged generally parallel next to one another that can be driven together in order to simultaneously feed a plurality of products, each of which a respective one of the conveying devices is associated to a cutting plane in which at least one cutting blade moves. Specifically, the cutting blade moves in a rotating and/or revolving manner. The conveying devices have a common drive and each include a transmission unit whose transmission ratio is variable in order to vary the individual conveying speeds of the conveying devices.

In accordance with another aspect of the invention, each of the conveying devices is not equipped with their own independent drive. Instead, a common drive is provided for all conveying devices. A separate transmission unit with a variable transmission ratio is associated with each conveying device for the variation as required of the individual conveying speed, with the individual conveying speed being influenced according to one aspect of the invention via the transmission ratio. In this manner, in particular the construction and manufacturing effort for a slicer of the generic kind can be substantially reduced since it is relatively simpler and less expensive in practice to provide a plurality of transmission units instead of a plurality of independent drives.

The possibility of forming the transmission units relatively simply and in particular with a relatively small transmission range is also possible. It was recognized in accordance with one embodiment of the invention that with a cutting device of the generic kind, products are to be sliced in practice that usually largely coincide with respect to their outer shape, and the products only vary to a relatively small degree with respect to their cross-sections. In order either to produce individual product slices or portions of product slices of the same weight, the products can therefore substantially be conveyed at the same speed, with only relatively slight adaptations being required for a substantially exact observance of the predefined slice weight or portion weight. These adaptations are not only relatively slight for each product, but are also additionally in the same order of magnitude for all products to be sliced simultaneously. One aspect of the invention utilizes this circumstance.

In accordance with an embodiment of the invention, the transmission unit can be connected between the common drive and the associated conveying device in order to allow an individually adjustable individual conveying speed for each conveying device with a drive provided in common for all conveying devices. The transmission unit in this embodiment forms a component separate from the common drive and from the corresponding conveying device.

In accordance with an alternative embodiment of the invention, the transmission unit is integrated into the conveying device. This therefore means that the transmission unit is not a separate component, but rather forms a part of the conveying device itself. An additional component is not required in such an embodiment.

The transmission ratios of the transmission units are preferably each variable in a stepless manner to generally ensure a substantially exact adaptation of the respective individual conveying speeds to the current circumstances or to the respective requirements.

In accordance with a further embodiment of the invention, the transmission units each have a primary shaft drivable by the common drive, a secondary shaft by which the conveying device can be driven, and a transmission for transmitting a rotary movement from the primary shaft to the secondary shaft in accordance with a variable transmission ratio. Depending on the application, a single primary shaft can be provided that is common to all transmission units, or a separate primary shaft can be provided as an input shaft for each transmission unit, with the common drive being coupled drive-effectively to each of the individual primary shafts. The secondary shafts, as output elements of the transmission units, ultimately transmit the drive torque provided by the drive to the conveying devices. Transmissions having a variable transmission ratio, which can in particular be varied steplessly are known in different embodiments in the prior art, for example.

An adjustment apparatus may be associated with each transmission unit and is configured to vary the transmission ratio of the transmission, and thus the individual conveying speeds of the conveying devices individually. The adjustment apparatus for the transmission units can be configured in different manners depending on the transmission type. This is possible due to the adjustment apparatus to control the individual conveying speed of each conveying device within the framework of the transmission range. Apart from the individual variation of the individual conveying speeds, a common variation of all individual conveying speeds can also be effected via a control of the common drive.

In accordance with an embodiment of the invention, the transmission ratio of the transmission unit can be varied for each conveying device during the slicing operation with a running conveying device. The adaptation of the individual conveying speed can thus take place “online” so-to-say without a delay or interruption of the ongoing cutting operation being necessary. Products having a cross-sectional shape variable in the longitudinal direction can thus in particular also be sliced while maintaining a uniform slice weight or portion weight, which requires a constant adaptation of the individual conveying speed during the slicing.

In accordance with an embodiment of the invention, each transmission unit includes a belt having two runs extending between a primary shaft and a secondary shaft. The barrel diameter of the primary shaft and/or of the secondary shaft can be varied individually in the region of the belt for each transmission unit in order to vary the speed of the secondary shaft in relation to the speed of the primary shaft.

In accordance with a further embodiment of the invention, the extent of the belt in the two runs can be varied for each transmission unit while maintaining the total extent. By such a direct variation of the extent of the belt in the runs, while maintaining the total extent (that is for example by an extent increase in the upper run with a simultaneous extent reduction in the lower run) the speed of the secondary shaft can be temporarily varied despite the unchanging speed of the primary shaft. Since the speed of the secondary shaft is variable, the individual conveying speed can be individually varied for each individual conveying device while keeping the speed of the primary shaft constant. An extent influencing can be effected, for example, by means of a dancer roll arrangement.

In accordance with a further embodiment of the invention, the conveying devices are each formed as a belt conveyor having a continuous belt band serving as a product support for a product to be sliced. Each belt conveyor can include in input roll, a roller and a continuous belt band running about the input roll and the roller, with the input roll being rotationally fixedly connected to a drive element of the transmission unit. A variation of the web speed of the circulating belt band of the belt conveyor is directly affected by a variation of the speed of the output element of the transmission unit.

An upper belt band which is configured to act on the upper side of the product can be associated with each belt band. In particular, each upper belt band is able to be driven and synchronized with its belt band serving as a product support. The product is then conveyed, as in the initially named prior art to this extent, by the lower band belt and the upper band belt together. Each upper belt band can be driven and synchronized with its belt band serving as a product support. Alternatively, the upper belt band itself can be made without a drive and only free-running so that the upper belt unit exerts a holding-down function, whereby a particularly reliable product positioning, product holding, or product guidance is achieved during the slicing. The product to be sliced is therefore so-to-say clamped between two circulating belt bands disposed opposite one another and is conveyed in this manner.

In yet another embodiment of the invention, a method for cutting food products to form product slices of each food product is provided. The method includes the step of simultaneously supplying a plurality of food products to a cutting plane. At least one cutting blade moves by means of a product feed, which includes a plurality of conveying devices arranged next to one another. The method further includes driving all the conveying devices by a common drive via respective transmission units which are each connected between the common drive and the associated conveying device. The method also includes individually varying the transmission ratio of each transmission unit as required for each conveying device to individually set the thickness of the product slices to be cut off for each food product.

In the method in accordance with another embodiment of the invention, a plurality of products are simultaneously fed to a cutting plane in which at least one cutting blade moves, in particular in a rotating and/or revolving manner, by means of a product feed that includes a plurality of conveying devices arranged generally parallel next to one another. The conveying devices are all driven together by means of a common drive via respective transmission units which are connected between the common drive and the associated conveying device. The transmission ratio of the transmission unit is varied individually as required for each conveying device to set the thickness of product slices to be cut off individually for each product.

In accordance with yet another embodiment, the transmission units each include a primary shaft, a transmission and a secondary shaft, with each conveying device being driven by the common drive via the associated secondary shaft of the transmission unit.

In accordance with an embodiment of the invention, the transmission ratio of the transmission unit is varied for each conveying device in dependence on the contour of the product, with the contour of the product preferably being determined by a detection device integrated in the device.

### BRIEF DESCRIPTION OF THE DRAWINGS

The invention will be described in the following by way of example with reference to the drawings.

FIG. 1A shows a cutting device in accordance with an embodiment of the invention in a schematic diagram;

FIG. 1B shows an example for a cutting device in accordance with FIG. 1A in a more detailed representation;

FIG. 2A shows a cutting device in accordance with another embodiment of the invention in a schematic diagram; and

FIG. 2B shows an example for a cutting device in accordance with FIG. 2A in a more detailed representation.

### DETAILED DESCRIPTION

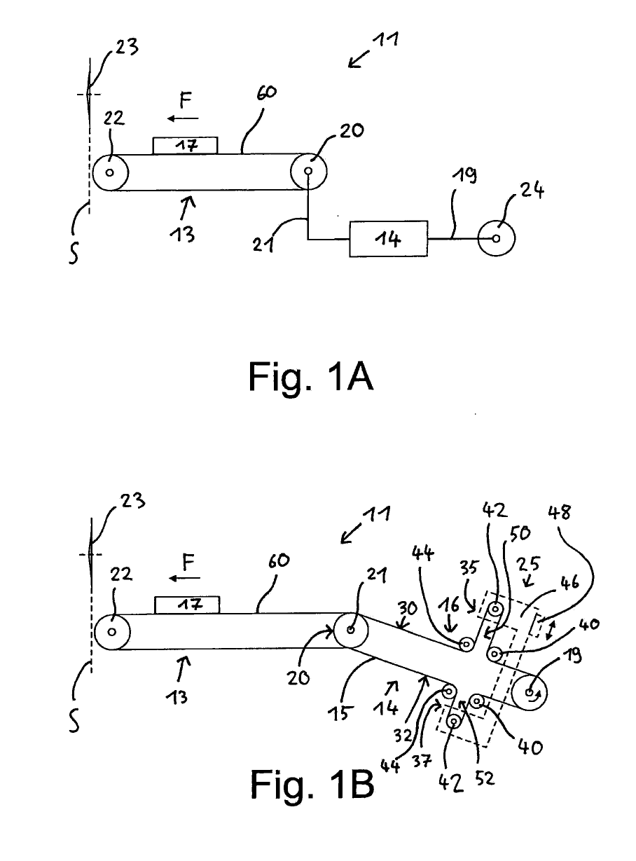

A cutting device or apparatus in accordance with an embodiment of the invention is shown in FIGS. 1A and 1B. The cutting device includes a product feed 11 having a plurality of conveying devices 13 that are arranged next to one another, and are aligned generally parallel with one another such that in each case only one is shown in the Figures. The conveying devices 13 are each formed as belt conveyors having an input roll 20, a roller 22 and a continuous belt band 60 serving as a product support for a product 17 to be sliced. The continuous belt band 60 can, for example, be a flat toothed belt. The rollers 22 are arranged close to a cutting plane S.

The products 17 lying on the belt conveyors 13 are fed simultaneously and are generally parallel to one another along a product conveying direction F to the cutting plane S by driving the input rolls 20.

A cutting blade 23 rotates in a planetary motion in the cutting plane S. In one embodiment, a cutting blade such as, for example, a scythe blade is provided that does not revolve in a planetary motion, but only rotates. The cutting blade 23 cuts substantially through all supplied products 17 at a constant cutting frequency so that the product slices cut off from the products 17 are thicker if the instantaneous individual conveying speed of the respective belt conveyer 13 is higher.

A drive 24 common to all belt conveyors 13 is provided, e.g. an electric motor with an associated output shaft, which provides a driving torque for each of the belt conveyors 12. Furthermore, a transmission unit 14, shown schematically, is connected in each case between the drive 24 and the associated belt conveyor 13. The transmission unit 14 has a translation ratio which can be varied steplessly and is accordingly able to adapt the individual conveying speed of each belt conveyor 13.

An embodiment of the transmission unit 14 will be described in more detail with reference to FIG. 1B. The transmission unit 14 includes a primary shaft 19, a secondary shaft 21 and a transmission 16 by means of which a rotary movement can be transmitted from the primary shaft 19 to the secondary shaft 21. The transmission unit 14 is formed as a belt drive having a belt 15 rotating about the primary shaft and the secondary shaft 21. Each belt drive 14 has an upper run 30 and a lower run 33 which each extend between the primary shaft 19 and the secondary shaft 21. The belt drives 14 are driven by the primary shaft 19 which is common to all belt drives 14, and is drive-effectively coupled to the drive 24 (not shown in FIG. 1B). Alternatively, each belt conveyor 13 can have a separate primary shaft 19 which is drive-effectively coupled to the common drive 24—optionally via further transmission elements. The secondary shaft 21 is in turn drive-effectively connected to the input roll 20 of the associated belt conveyor 13. The drive 24 thus drives each of the belt conveyors 13 via the belt drive 14 at a predefined rotational speed.

An adjustment apparatus 25 is associated with each belt drive 14 and includes an upper deflection device 35 for the belt 15 arranged at the upper run 30, as well as a lower deflection device 37 for the belt 15 arranged at the lower run 32. Each of the deflection devices 35, 37 includes a first deflection roll 40, a dancer roll 42 as well as a second deflection roll 44, about which the belt 15 rotates. Whereas the deflection rolls 40, 44 are in fixed position, the two dancer rolls 42 are mounted on a common carrier 46 that is displaceable at substantially right angles to the product conveying apparatus F relative to the primary shaft 19 by means of an adjustment apparatus 48.

The deflection devices 35, 37 each define a loop 50, 52 for the belt 15, whereby the total extent of the belt 15 is increased with respect to a configuration with straight-line runs. On a displacement upward of the carrier 46 in FIG. 1B, the extent of the belt 15 in the upper rum 30 increases, whereas the extent of the belt 15 in the lower run 32 decreases by a substantially equal amount. The total extent of the belt 15 remains constant. The upper loop 50, however, takes up an additional belt section during the upward movement of the carrier 46 so that the belt section running onto the secondary shaft 21 per time unit is shorter than the belt section running off from the primary shaft 19. The speed of the secondary shaft 21 accordingly reduces during the upward displacement of the carrier 46, and thus also the individual conveying speed of the corresponding belt conveyor 13. An increase in the speed of the secondary shaft 21, and thus of the individual conveying speed of the belt conveyor 13 results in an analog manner during a downward movement of the carrier.

The belt drive 14 thus forms an intermediate transmission which is steplessly adjustable between the common drive 24 and the belt conveyor 13. The individual conveying speeds of each belt conveyor 13 can be either accelerated or decelerated by controlling the adjustment apparatus 48, and by a corresponding linear displacement of the carriers 46. Since a separate adjustment apparatus 25 is associated with each belt conveyor 13, the individual conveying speeds can be varied individually. The variation is restricted to the time period of the movement of the carrier 46 in the embodiment shown. For the applications relevant in practice, such a dynamic adaptation of the individual conveying speeds is generally sufficient to ensure the desired constancy of the slice weight or portion weight for each of the products 17 to be sliced simultaneously. A permanent adaptation could, however, also be provided instead of a dynamic adaptation. For this purpose, the transmission unit 14 could, for example, be formed as a cone ring transmission or as a V belt transmission with cone disks displaceable relative to one another. Alternatively or additionally, toothed belt offset drives or link chain drives can be integrated into the transmission unit 14.

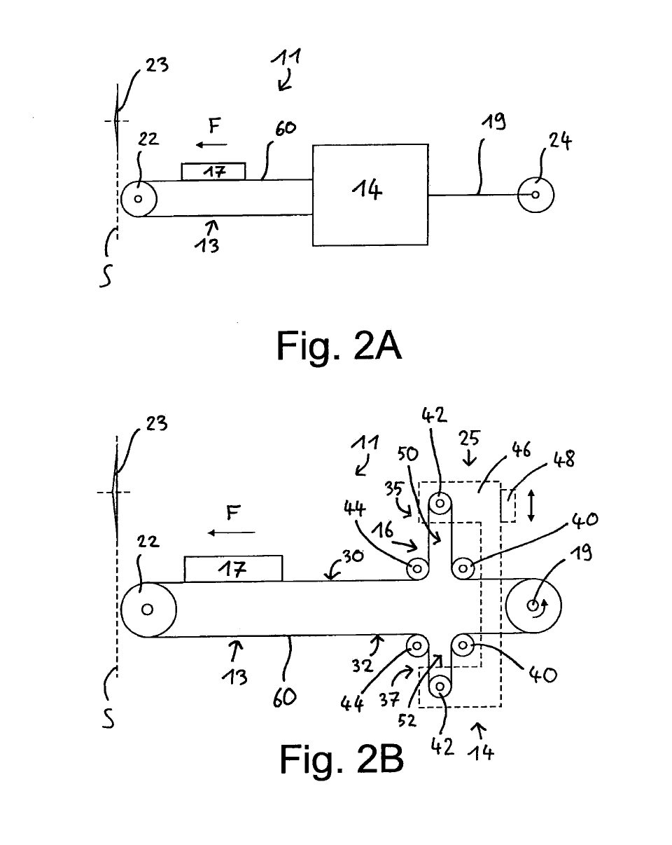

A further embodiment of a cutting apparatus or device in accordance with the invention is shown in FIGS. 2A and 2B. In this embodiment, each transmission unit 14 in accordance with FIG. 2A is integrated into the belt conveyor 13. As can be seen from FIG. 2B, the adjustment apparatus 25 with the upper deflection device 35 and the lower deflection device 37 is directly included in the belt conveyor 13, (i.e. the belt band 60 runs around the deflection rolls 40, 44 as well as around the dancer rolls 42). On an upward displacement of the carrier 46 by means of the adjustment apparatus 48, the web speed of the belt band 60 is reduced. The reduction is limited to the section of the upper run 30 between the upper deflection device 35 and the roller 22, and to the section of the lower run 32 between the roller 22 and the lower deflection device 37, as well as to the time period of the upward movement of the carrier 46. An increase in the web speed of the belt band 60 during a downward movement of the carrier 46 results in an analog manner. Since the belt speed of the belt band 60 ultimately represents the individual conveying speed of the belt conveyor 13, the adjustment apparatus 25 forms a transmission 16 which is integrated into the belt conveyor 13, and which is steplessly adjustable.

Since, in accordance with an embodiment of the invention, the individual conveying speeds of the belt conveyors 13 are individually adjustable, the thicknesses of the cut off product slices can be adapted individually for each belt conveyor 13 without a separate drive 24 having to be provided for each belt conveyor 13 for this reason. The effort and the costs for the provision of the product feed 11 in accordance with the invention and thus of the total slicer can thus be reduced. A constant slice weight or portion weight can in particular be ensured for all simultaneously fed products 17 despite product cross-sectional surfaces varying in the longitudinal product direction.

1-15. (canceled)

16. A device for cutting food products for a slicer, comprising
a product feed which includes a plurality of conveying devices arranged generally parallel next to one another, each having a conveying speed for simultaneously feeding a plurality of food products to a cutting plane, a respective one of the plurality of conveying devices being associated with each of the plurality of food products,
at least one cutting blade configured for moving in the cutting plane,
a common drive for the plurality of conveying devices, and
respective transmission units for each of the plurality conveying devices, each transmission unit having a variable transmission ratio, the transmission ratios being variable to individually vary each of the conveying speeds of the plurality of conveying devices.

17. The device in accordance with claim 16, the cutting blade being configured to move in at least one of a rotating and a revolving manner.

18. The device in accordance with claim 16, each transmission unit being connected between the common drive and an associated conveying device.

19. The device in accordance with claim 16, each transmission unit being integrated into a respectively associated conveying device.

20. The device in accordance with claim 16, the transmission ratio of each of the transmission units being steplessly variable.

21. The device in accordance with claim 16, each transmission unit having a primary shaft drivable by the common drive, a secondary shaft by which the plurality of conveying devices is drivable and a transmission for transmitting a rotary movement from the primary shaft to the secondary shaft in accordance with a variable transmission ratio.

22. The device in accordance with claim 16, wherein an adjustment apparatus is associated with each transmission unit and is configured to individually vary the transmission ratio of the transmission unit and an individual conveying speed of an associated conveying device.

23. The device in accordance with claim 16, the transmission ratio of the transmission unit for each of the plurality of conveying devices being variable during a slicing operation while the plurality of conveying devices are running

24. The device in accordance with claim 16, wherein each transmission unit includes a belt having a first run and a second run extending between a primary shaft and a secondary shaft.

25. The device in accordance with claim 24, wherein at least one of the primary shaft and the secondary shaft of each transmission unit has a barrel diameter which is individually variable in a region of the belt.

26. The device in accordance with claim 25, each belt having a total length, a first run and a second run, and a respective barrel length in the first run and the second run, wherein the barrel lengths are variable for each transmission unit while maintaining the total length.

27. The device in accordance with claim 16, each of the plurality of conveying device configured as a belt conveyor having a continuous belt band serving as a product support for a food product to be sliced.

28. The device in accordance with claim 27, each belt band having an associated upper belt band configured to act on an upper side of a respective food product.

29. The device in accordance with claim 28, wherein each upper belt band is able to be driven synchronized with the respectively associated belt band serving as a product support.

30. A method for cutting food products to form at least one product slice of each food product, the method comprising the steps of:
simultaneously supplying a plurality of food products to a cutting plane in which at least one cutting blade moves by a product feed, which includes a plurality of conveying devices arranged next to one another,
driving all the plurality of conveying devices by a common drive via respective transmission units which are each connected between the common drive and an associated one of the plurality of conveying devices; and
individually varying a transmission ratio of each of the transmission units as required for each of the plurality of conveying devices to individually set a thickness of the at least one product slice to be cut off for each food product.

31. A method in accordance with claim 30, the transmission units each including a primary shaft, a transmission, and a secondary shaft, and the method comprising driving each of the plurality of conveying devices by the common drive via an associated secondary shaft of a respectively associated transmission unit.

32. A method in accordance with claim 30, including determining a contour of each food product.

33. A method in accordance with claim 32, the contour of each food product determined using a detection device integrated into the device.

34. A method in accordance with claim 30, including varying the transmission ratio of the transmission unit for each of the plurality of conveying devices in dependence on the contour of each food product.
